(19) United States
(12) Patent Application Publication
(10) Pub. No.: US 2026/0321506 A1
(43) Pub. Date: Oct. 15, 2026

(54) MULTILAYER CERAMIC CAPACITOR

(71) Applicant: Murata Manufacturing Co., Ltd., Nagaokakyo-shi (JP)

(72) Inventors: Sadayuki KOIZUMI, Nagaokakyo-shi (JP); Toshihiko KOBAYASHI, Nagaokakyo-shi (JP); Takefumi TAKAHASHI, Nagaokakyo-shi (JP)

(21) Appl. No.: 19/464,841

(22) Filed: Jan. 30, 2026

Related U.S. Application Data
(63) Continuation of application No. PCT/JP2024/023834, filed on Jul. 1, 2024.

(30) Foreign Application Priority Data
Aug. 30, 2023 (JP) 2023-139689

(51) Int. Cl. H01G 4/30; H01G 4/008; H01G 4/012; H01G 4/232

(52) U.S. Cl. CPC H01G 4/30; H01G 4/0085; H01G 4/012; H01G 4/2325

(57) ABSTRACT

A multilayer ceramic capacitor with reduced distortion in a vicinity of an interface of a terminal electrode of a ceramic layer includes an external electrode including a first metal grain. In a cross section parallel to a height direction and a length direction, two or more grain boundaries of the first metal grain are present at a junction between an internal electrode and the external electrode, and a grain size of the first metal grain in which the grain boundary is present in the junction is about 1.2 times or less of a thickness in the height direction of the internal electrode.

### CROSS REFERENCE TO RELATED APPLICATIONS

This application claims the benefit of priority to Japanese Patent Application No. 2023-139689 filed on Aug. 30, 2023 and is a Continuation Application of PCT Application No. PCT/JP 2024/023834 filed on Jul. 1, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

The level of reliability required for multilayer ceramic capacitors is increasing. The reliability of multilayer ceramic capacitors may be reduced by stress acting on the multilayer ceramic capacitors. Japanese Unexamined Patent Application Publication No. 2000-215729 discloses an electrically conductive paste that is used for ceramic electronic components and provides an electrically conductive configuration capable of withstanding stress.

### SUMMARY OF THE INVENTION

In conventional multilayer ceramic capacitors, a large amount of strain exists in the ceramic layers near the interface with the terminal electrodes. This strain reduces the reliability of the multilayer ceramic capacitors. No technology has been proposed for reducing strain in the ceramic layers near the terminal electrode interface.

Example embodiments of the present invention provide multilayer ceramic capacitors, each with reduced strain in ceramic layers at or adjacent to a terminal electrode interface.

An example embodiment of the present invention provides a multilayer ceramic capacitor which includes a ceramic base body including a plurality of ceramic layers and a plurality of internal electrodes that are laminated, and six surfaces including a first main surface and a second main surface opposed to each other in a height direction, a first lateral surface and a second lateral surface opposed to each other in a width direction orthogonal to the height direction, and a first end surface and a second end surface opposed to each other in a length direction orthogonal to the height direction and the width direction, and external electrodes each provided on the ceramic base body and each connected to a portion of the plurality of internal electrodes. Each of the external electrodes includes first metal grains. In a cross section parallel to the height direction and the length direction, two or more grain boundaries of the first metal grains are present at a bonding portion between the plurality of internal electrodes and a corresponding one of the external electrodes, and a grain diameter of the first metal grains each having a grain boundary present at the bonding portion is about 1.2 times or less a thickness of one of the plurality of internal electrodes in the height direction.

According to example embodiments of the present invention, it is possible to provide multilayer ceramic capacitors with reduced strain in ceramic layers at or adjacent to a terminal electrode interface.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to the present example embodiment of the present invention.

FIG. 2 is a cross-sectional view taken along the line I-I in FIG. 1.

FIG. 3 is a cross-sectional view taken along the line II-II in FIG. 1.

FIG. 4 is an SEM photograph of a portion corresponding to frame 90 in FIG. 2.

FIG. 5 is a diagram showing an aspect of bonding between internal electrodes and external electrodes.

FIG. 6 is a diagram showing another aspect of bonding between internal electrodes and external electrodes.

FIG. 7A is a grain map of first metal grains.

FIG. 7B is a histogram of grain diameters of first metal grains.

FIG. 8A is a grain map of conventional first metal grains.

FIG. 8B is a histogram of grain diameters of conventional first metal grains.

FIG. 9 is a stress map of inner ceramic layers.

FIG. 10 is a stress map of conventional inner ceramic layers.

FIG. 11 is an LT cross-sectional view showing an interface between internal electrodes and external electrodes before surface diffusion.

FIG. 12 is a perspective view showing an outline of ceramic base body 2.

### DETAILED DESCRIPTION OF THE EXAMPLE EMBODIMENTS

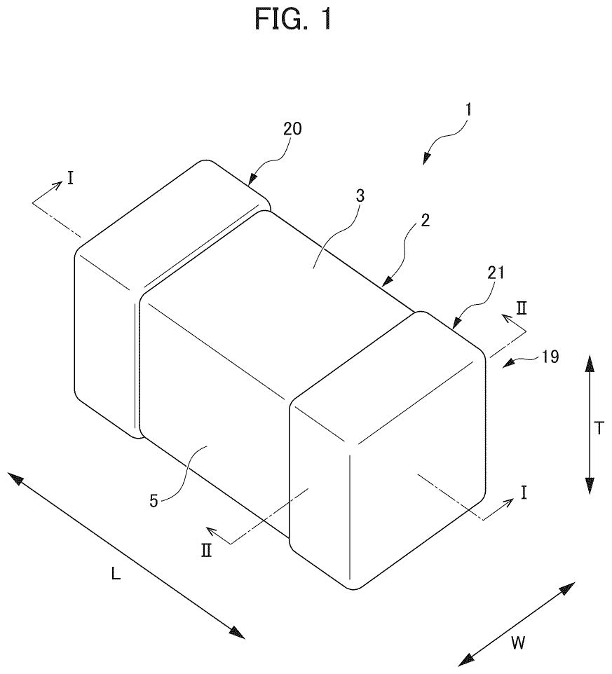

An example embodiment of the present invention will be described with reference to FIG. 1. FIG. 1 is a perspective view of a multilayer ceramic capacitor 1 according to an example embodiment of the present invention. FIG. 1 shows a so-called two-terminal multilayer ceramic capacitor. The multilayer ceramic capacitor 1 is not limited to a two-terminal multilayer ceramic capacitor. The multilayer ceramic capacitor 1 may be a multilayer ceramic capacitor including three or more terminals, such as three terminals.

The multilayer ceramic capacitor 1 includes a ceramic base body 2 and terminal electrodes 19. The terminal electrodes 19 include a first terminal electrode 20 and a second terminal electrode 21.

The ceramic base body 2 includes a plurality of laminated ceramic layers and a plurality of internal electrodes. The ceramic base body 2 has a substantially rectangular parallelepiped shape.

The direction in which the ceramic layers and the internal electrodes are laminated is referred to as a height direction T. The direction perpendicular to the height direction T is referred to as a width direction W. The direction perpendicular to the height direction T and the width direction W is referred to as a length direction L.

One of the two surfaces of the ceramic base body 2 opposed to each other in the height direction T is referred to as a first main surface 3. The remaining one surface is referred to as a second main surface 4. One of the two surfaces of the ceramic base body 2 opposed to each other in the width direction W is referred to as a first lateral surface 5. The remaining one surface is referred to as a second lateral surface 6. One of the two surfaces of the ceramic base body 2 opposed to each other in the length direction L is referred to as a first end surface 7. The remaining one surface is referred to as a second end surface 8.

Each cross section of the ceramic base body 2 is referred to as follows. The cross section taken along the line I-I in FIG. 1 is referred to as an LT cross section. The cross section taken along the line II-II in FIG. 1 is referred to as a WT cross section.

A portion where three surfaces of the ceramic base body 2 intersect is referred to as a corner portion of the ceramic base body 2. A portion where two surfaces of the ceramic base body 2 intersect is referred to as a ridge portion of the ceramic base body 2. The shapes of the corner portions and the ridge portions are preferably round.

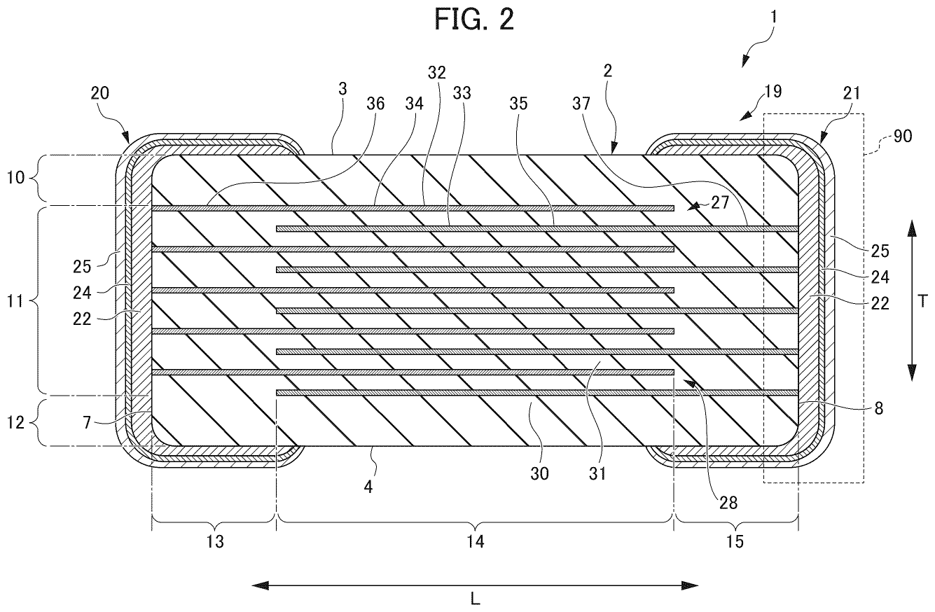

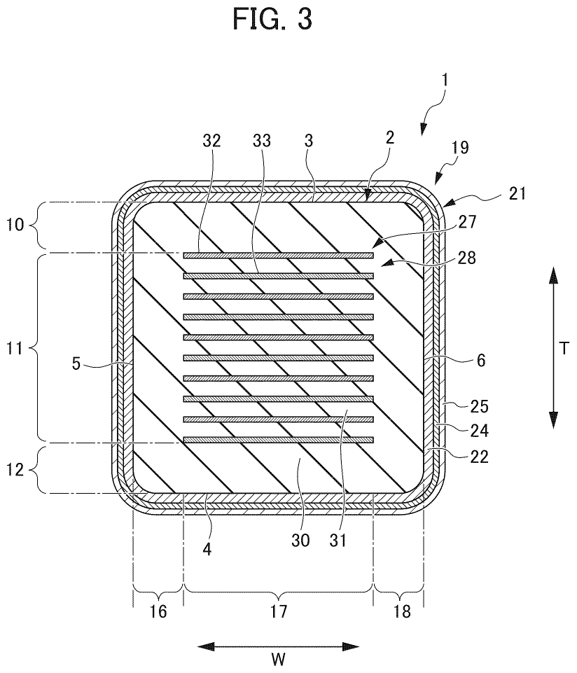

The division of the ceramic base body 2 will be described with reference to FIGS. 2 and 3. FIG. 2 is a cross-sectional view taken along the line I-I in FIG. 1. FIG. 3 is a cross-sectional view taken along the line II-II in FIG. 1. As shown in FIGS. 2 and 3, in the ceramic base body 2, internal electrodes 27 and ceramic layers 28 are laminated in the height direction T.

The division of the ceramic base body 2 in the height direction T will be described with reference to FIG. 2. The ceramic base body 2 is divided in the height direction T into a first main surface-side outer layer portion 10, an inner layer portion 11, and a second main surface-side outer layer portion 12.

The first main surface-side outer layer portion 10 is a portion between a plane including an internal electrode 27 closest to the first main surface 3 and the first main surface 3. The inner layer portion 11 is a portion between a plane including an internal electrode 27 closest to the first main surface 3 and a plane including an internal electrode 27 closest to the second main surface 4. The second main surface-side outer layer portion 12 is a portion between a plane including an internal electrode 27 closest to the second main surface 4 and the second main surface 4.

The division of the ceramic base body 2 in the length direction L will be described with reference to FIG. 2. The ceramic base body 2 is divided in the length direction L into a first end surface-side extension portion 13, a length direction counter portion 14, and a second end surface-side extension portion 15.

The length direction counter portion 14 is a portion where internal electrodes 27 and internal electrodes 27 that extend toward different end surfaces are opposed to each other in the height direction T. The first end surface-side extension portion 13 is a portion between the length direction counter portion 14 and the first end surface 7. The second end surface-side extension portion 15 is a portion between the length direction counter portion 14 and the second end surface 8.

The length direction counter portion 14 corresponds to the counter electrode portions of the internal electrodes 27. The first end surface-side extension portion 13 and the second end surface-side extension portion 15 correspond to extension electrode portions of the internal electrodes 27.

The division of the ceramic base body 2 in the width direction W will be described with reference to FIG. 3. The ceramic base body 2 is divided in the width direction W into a first lateral surface-side side gap portion 16, a width direction counter portion 17, and a second lateral surface-side side gap portion 18.

The width direction counter portion 17 is a portion where internal electrodes 27 that extend toward different end surfaces and internal electrodes 27 are opposed to each other in the height direction T. The first lateral surface-side side gap portion 16 is a portion between the width direction counter portion 17 and the first lateral surface 5. The second lateral surface-side side gap portion 18 is a portion between the width direction counter portion 17 and the second lateral surface 6.

The ceramic layers 28 include outer ceramic layers 30 and inner ceramic layers 31. The outer ceramic layers 30 are the ceramic layers 28 included in the first main surface-side outer layer portion 10 and the second main surface-side outer layer portion 12. The inner ceramic layers 31 are the ceramic layers 28 included in the inner layer portion 11.

Examples of the main material of the ceramic layers 28 include barium titanate, calcium titanate, strontium titanate, and calcium zirconate. The ceramic layers may include secondary materials. Examples of the secondary materials include manganese compounds, iron compounds, chromium compounds, cobalt compounds, and nickel compounds.

A preferred total number of the ceramic layers 28 laminated in the ceramic base body 2 is fifteen or more and 2000 or less, for example.

A preferred thickness of each layer of the ceramic layers 28 is about 0.3 μm or more and about 10 μm or less, for example.

The internal electrodes 27 will be described. The internal electrodes 27 include a plurality of first internal electrodes 32 and a plurality of second internal electrodes 33. The first internal electrodes 32 are internal electrodes 27 exposed at the first end surface 7. The second internal electrodes 33 are internal electrodes 27 exposed at the second end surface 8.

Each of the first internal electrodes 32 is divided into a first counter electrode portion 34 and a first extension electrode portion 36. Each of the first counter electrode portion 34 is a portion opposed to the second internal electrode 33. The first extension electrode portion 36 is a portion extending from the first counter electrode portion 34 toward the first end surface 7.

Each of the second internal electrodes 33 is divided into a second counter electrode portion 35 and a second extension electrode portion 37. Each of the second counter electrode portions 35 is a portion opposed to the first internal electrode 32. The second extension electrode portion 37 is a portion extending from the second counter electrode portion 35 toward the second end surface 8.

Examples of materials for the internal electrodes 27 are nickel, copper, silver, palladium, and gold. The material of the internal electrodes may be an alloy containing at least one of the aforementioned metals, such as a silver-palladium alloy.

The preferred thickness of the internal electrodes 27 is about 0.3 μm or more and about 2.0 μm or less, for example. The preferred total number obtained by adding the number of first internal electrodes 32 and the number of second internal electrodes 33 is fifteen or more and two thousand or less, for example.

The size of the ceramic base body 2 is not particularly limited. A preferred length of the ceramic base body 2 in the length direction L is about 0.2 mm or more and about 10 mm or less, for example. A preferred length of the ceramic base body 2 in the width direction W is about 0.1 mm or more and about 5 mm or less, for example. A preferred length of the ceramic base body 2 in the height direction T is about 0.1 mm or more and about 5 mm or less, for example.

The terminal electrodes 19 will be described. As described above, the terminal electrodes 19 include the first terminal electrode 20 and the second terminal electrode 21. The first terminal electrode 20 is the terminal electrode 19 connected to the first internal electrode 32. The second terminal electrode 21 is the terminal electrode 19 connected to the second internal electrode 33.

The first terminal electrode 20 is provided on the first end surface 7, a portion of the first main surface 3, a portion of the second main surface 4, a portion of the first lateral surface 5, and a portion of the second lateral surface 6. The second terminal electrode 21 is provided on the second end surface 8, a portion of the first main surface 3, a portion of the second main surface 4, a portion of the first lateral surface 5, and a portion of the second lateral surface 6.

The terminal electrodes 19 include the external electrodes 22, nickel plating films 24, and tin plating films 25. These are provided in the order of the external electrodes 22, the nickel plating films 24, and the tin plating films 25 from the surface of the ceramic base body 2.

Each of the external electrodes 22 is provided on the end surface of the ceramic base body 2. Each of the external electrodes 22 covers the end surface. Each of the external electrodes 22 extends from the end surface to a portion of the main surface and a portion of the lateral surface.

Each of the external electrodes 22 includes a metal and glass. Examples of the metal include copper, nickel, silver, palladium, silver-palladium alloy, and gold. Each of the external electrodes 22 is formed by applying an electrically conductive paste including a metal and glass to the ceramic base body 2, and then firing the resultant product. The metal is included in the electrically conductive paste as metal powder. The glass is included in the electrically conductive paste as glass powder. The preferred thickness of the external electrode 22 is about 3 μm or more and about 25 μm or less, for example.

The nickel plating film 24 covers the external electrode 22. The tin plating film 25 covers the nickel plating film 24.

The nickel plating film 24 reduces or prevents the external electrode 22 from being eroded by solder when mounting the multilayer ceramic capacitor 1. The tin plating film 25 improves the wettability of solder when mounting the multilayer ceramic capacitor 1.

The size of the multilayer ceramic capacitor 1 is not particularly limited. The preferred length direction dimension of the multilayer ceramic capacitor 1 including the ceramic base body 2 and the terminal electrodes is about 0.2 mm or more and about 10 mm or less, for example. The preferred height direction dimension of the multilayer ceramic capacitor 1 is about 0.1 mm or more and about 5 mm or less, for example. The preferred width direction dimension of the multilayer ceramic capacitor 1 is about 0.1 mm or more and about 10 mm or less, for example.

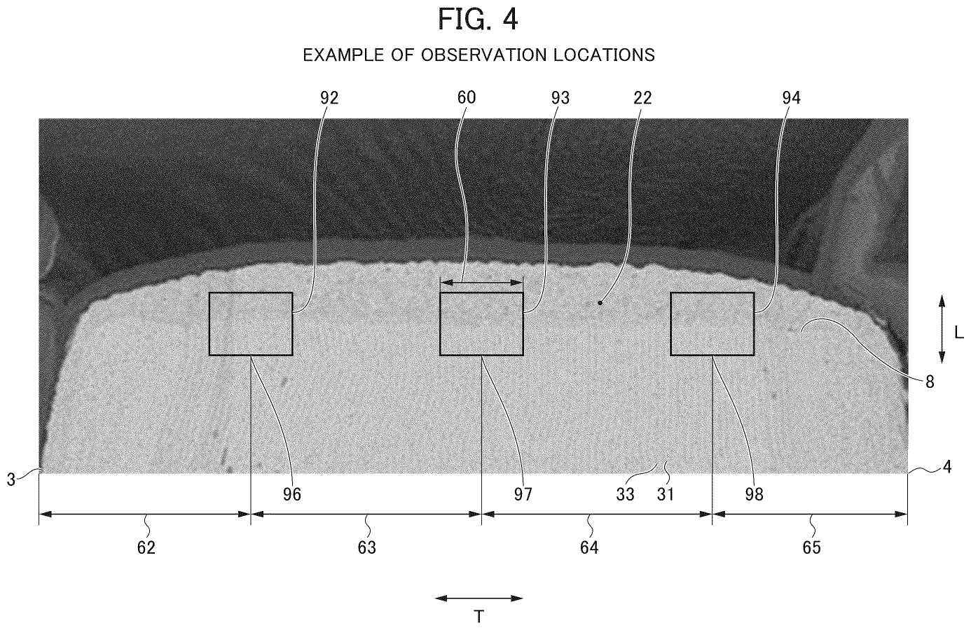

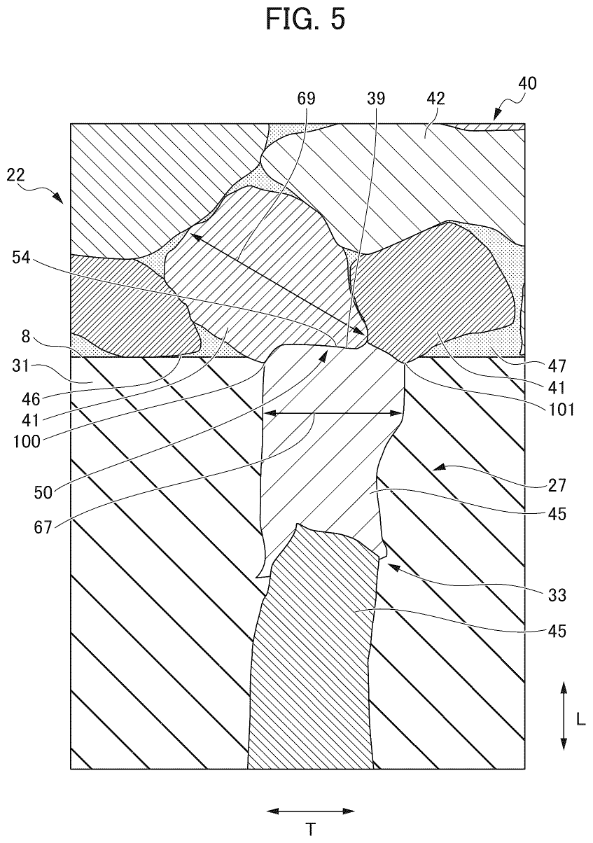

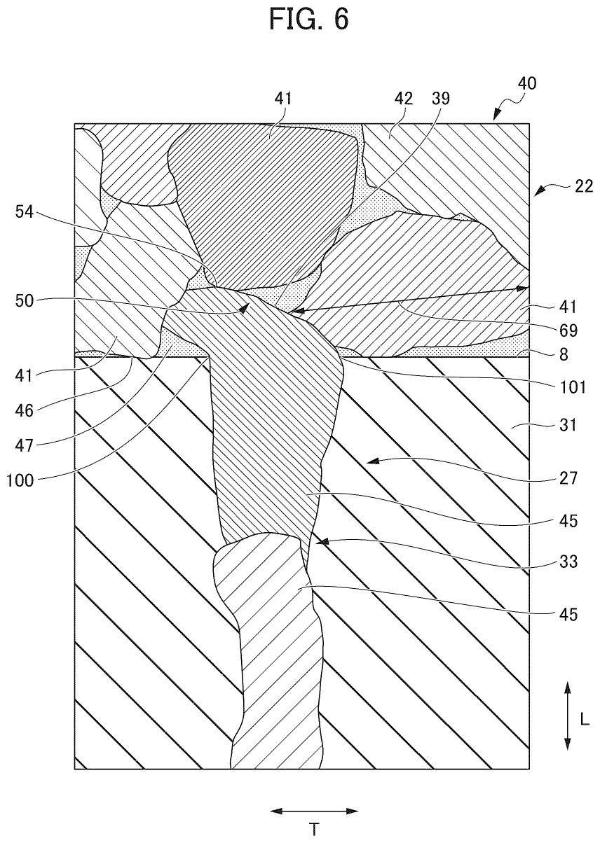

The external electrode 22 will be described in detail. FIG. 4 is an SEM photograph of a portion corresponding to the frame 90 in FIG. 2. FIG. 4 shows an LT cross section near the second end surface 8. FIG. 4 shows the three frames of a frame 92, a frame 93, and a frame 94. FIGS. 5 and 6 each show an enlarged view of a portion of the frame 92.

Each of FIGS. 5 and 6 is a view showing the aspect of bonding between the second internal electrode 33 and the external electrode 22. The configuration of the tip 54 of the second internal electrode 33 is different between FIGS. 5 and 6.

The tip 54 of the second internal electrode 33 shown in FIG. 5 is substantially on the same plane as the second end surface 8. The tip 54 of the second internal electrode 33 shown in FIG. 6 protrudes from the second end surface 8 toward the external electrode 22 in the length direction L.

With reference to FIG. 5, an aspect of bonding between the second internal electrode 33 and the external electrode 22 will be described. The second internal electrode 33 includes a plurality of second metal grains 45. The second metal grains are particles of a metal included in the internal electrodes 27, for example, nickel. The second metal grains 45 at the tip 54 of the second internal electrode 33 are in contact with the external electrode 22 at the bonding portion 50.

The bonding portion 50 will be described. In the LT cross section of the multilayer ceramic capacitor 1, points where the second end surface 8 contacts the second internal electrode 33 are indicated by the point 100 and the point 101. A contour 39 of the second internal electrode 33 in the LT cross section from the point 100, through the tip 54 of the second internal electrode 33, to the point 101 is defined as the bonding portion 50.

The internal electrode 27 faces the external electrode 22 at the bonding portion 50. The internal electrode 27 facing the external electrode 22 includes the internal electrode 27 that is in contact with the external electrode 22 and the internal electrode 27 that is opposed to and adjacent to the external electrode 22.

Furthermore, each of the external electrodes 22 includes metal and glass. The internal electrode 27 facing the external electrode 22 includes the internal electrode 27 that faces a metal portion of the external electrode 22 (such as the first metal grain 40), and the internal electrode 27 that faces a glass portion of the external electrode 22 (such as the glass portion 47).

Each of the external electrodes 22 includes a plurality of first metal grains 40 and glass portions 47. The first metal grains 40 are particles of metal, for example, copper, included in the external electrodes 22. The glass portions 47 are portions made of glass components included in the external electrode 22.

In the multilayer ceramic capacitor 1 of the present example embodiment, in the LT cross section, two or more grain boundaries 46 of the first metal grains 40 exist at the bonding portion 50 between the internal electrode 27 and the external electrode 22.

In addition, the grain diameter of the first metal grains 40 including grain boundaries 46 existing at the bonding portion 50 is about 1.2 times or less, for example, of the thickness 67 of the internal electrode in the height direction T.

As shown in FIG. 5, the first metal grains 40 include metal grains having grain boundaries 46 in contact with the bonding portion 50 and metal grains having grain boundaries 46 not in contact with the bonding portion 50. The metal grains having grain boundaries 46 in contact with the bonding portion 50 are referred to as bonding metal grains 41. The metal grains having grain boundaries 46 not in contact with the bonding portion 50 are referred to as non-bonding metal grains 42.

In the example shown in FIG. 5, two bonding metal grains 41 are in contact with the second internal electrode 33 at the bonding portion 50. There are two bonding metal grains 41 for one second internal electrode 33.

The double-headed arrow 67 in FIG. 5 indicates the thickness 67 of the internal electrode 27 in the height direction T. The double-headed arrow 69 indicates the grain diameter 69 of the bonding metal grain 41. The grain diameter 69 of the bonding metal grain 41 is about 1.2 times or less, for example, of the thickness 67.

In the multilayer ceramic capacitor 1 of the present example embodiment, in the LT cross section, the thickness 67 is about 0.3 μm or more and about 2.0 μm or less, for example. The grain diameter of the bonding metal grains 41 is about 0.1 μm or more and about 0.8 μm or less, for example.

In the multilayer ceramic capacitor 1 of the present example embodiment, the glass portions 47 are in contact with at least one of the internal electrode 27 or the ceramic layer 28.

With reference to FIG. 6, another aspect of bonding between the second internal electrode 33 and the external electrode 22 will be described. For FIG. 6, matters different from FIG. 5 will be mainly described. As described above, the tip 54 of the second internal electrode 33 shown in FIG. 6 protrudes from the second end surface 8 toward the external electrode 22 in the length direction L.

In the example shown in FIG. 6, there are three bonding metal grains 41 for one second internal electrode 33. When the tip 54 of the second internal electrode 33 protrudes from the second end surface 8 toward the external electrode 22, the length of the bonding portion 50 becomes longer compared to the case where it does not protrude. Therefore, the grain boundary 46 of the first metal grain 40 is more likely to exist at the bonding portion 50.

The grain diameter of the first metal grains 40 will be described. Among the first metal grains 40, the coefficient of variation of the grain diameter of the bonding metal grains 41 is 20% or less. The coefficient of variation of the grain diameter of the bonding metal grains 41 in the present example embodiment is smaller than the coefficient of variation of the grain diameter of conventional bonding metal grains 41.

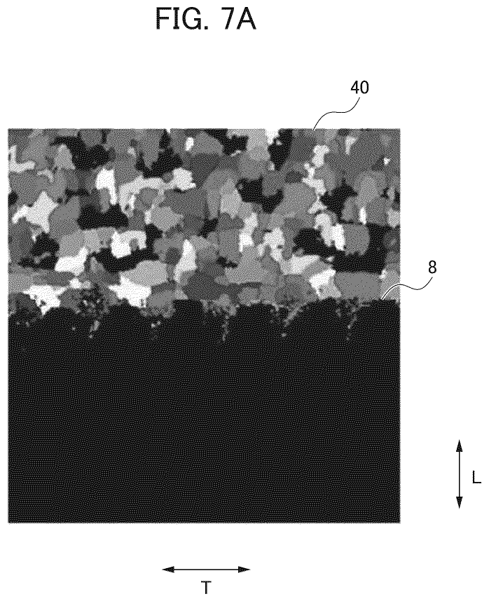

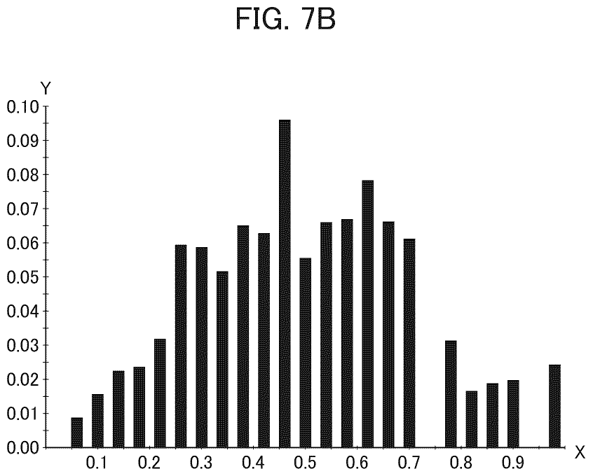

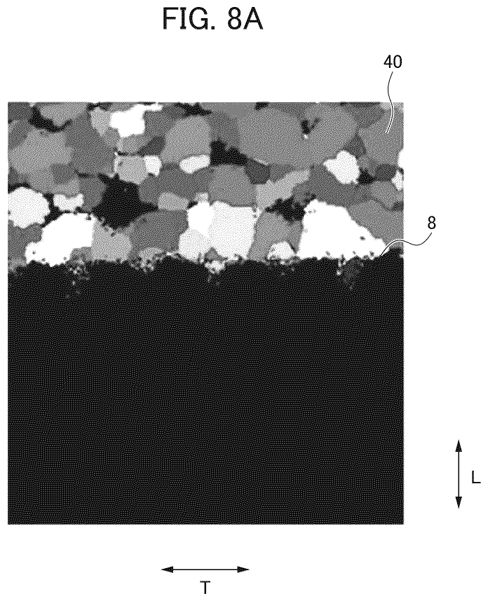

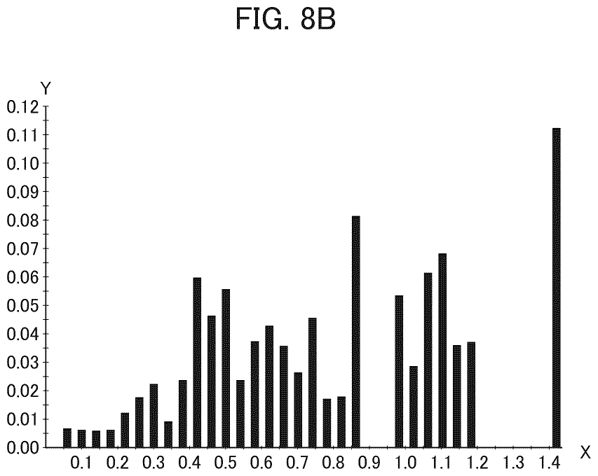

FIG. 7A is a grain map of the first metal grains 40 of the present example embodiment. FIG. 7B is a histogram of the grain diameter of the first metal grains 40 of the present example embodiment. FIG. 8A is a grain map of conventional first metal grains 40. FIG. 8B is a histogram of the grain diameter of conventional first metal grains 40. The X-axis of FIGS. 7B and 8B indicates the grain diameter (μm). The Y-axis of FIGS. 7B and 8B indicates the area fraction (area ratio).

FIGS. 7A and 8A show the results of EBSD (electron backscatter diffraction) analysis of the first metal grains 40. The samples for EBSD analysis are prepared as follows. The multilayer ceramic capacitor 1 after firing is embedded in resin. Thereafter, the sample is obtained by polishing until a predetermined surface is exposed, and surface trimming.

As can be seen from comparison between FIG. 7A and FIG. 8A, as an overall tendency, the particle size of the first metal grains 40 of the present example embodiment is smaller than the particle size of conventional first metal grains 40.

The histogram of FIG. 7B shows the particle size of the first metal grains 40 obtained from the EBSD analysis shown in FIG. 7A. The histogram of FIG. 8B shows the particle size of the first metal grains 40 obtained from the EBSD analysis shown in FIG. 8A.

As can be seen from the comparison between FIG. 7B and FIG. 8B, the particle size distribution of the first metal grains 40 of the present example embodiment is narrower than the particle size distribution of conventional first metal grains 40.

The first metal grains 40 of the present example embodiment, unlike conventional first metal grains 40, do not include particles having a particle size exceeding about 1.0 μm, for example.

In the multilayer ceramic capacitor 1 of the present example embodiment, the particle size distribution of the first metal grains 40 is narrow, and the first metal grains 40 do not include large particles having a particle size exceeding about 1.0 μm, for example. Therefore, in the LT cross-section, it is possible to easily provide two or more grain boundaries 46 of the first metal grains 40 at the bonding portion 50.

In a configuration where the size of the first metal grains 40 of the terminal electrode 19 is non-uniform, variation in the bonding state between the terminal electrode 19 and the internal electrode 27 is likely to occur. As a result, the strain included in the ceramic layer 28 increases.

The strain in the ceramic layer 28 will be described. As the size of the first metal grains 40 becomes more uniform, the bonding state between the terminal electrode 19 and the internal electrode 27 is stabilized. As a result, the strain included in the ceramic layer 28 is reduced. In particular, as the number of grain boundaries of the first metal grains 40 in contact with the second internal electrode 33 increases, interdiffusion between the second internal electrode 33 and the first metal grains 40 is promoted. This interdiffusion is also called the Kirkendall effect. The interdiffusion between the second internal electrode 33 and the first metal grains 40 is, for example, interdiffusion between nickel and copper. By promoting the interdiffusion, the bonding state between the terminal electrode 19 and the internal electrode 27 is stabilized. As a result, the strain in the ceramic layer 28 is reduced.

The strain portion 52 of the ceramic layer 28 will be explained. The strain portion 52 exists in the ceramic layer 28. The strain portion 52 refers to a portion in the ceramic layer 28 where internal stress concentrates. The strain portion 52 is identified from an image captured by photographing the ceramic layer 28 using an EBSD (electron backscatter diffraction) technique. A method for identifying the strain portion 52 will be explained later. Hereinafter, the strain portion 52 will be described using the inner ceramic layer 31 as an example.

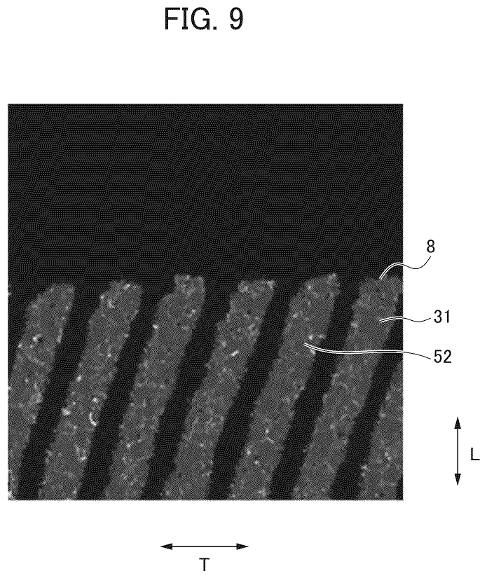

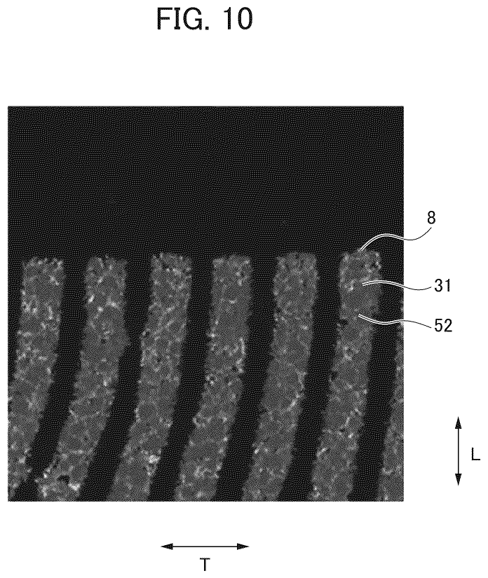

FIG. 9 is a stress map of the inner ceramic layer 31. FIG. 10 is a stress map of a conventional inner ceramic layer 31. As can be understood from comparison between FIG. 9 and FIG. 10, the strain portions 52 existing in the inner ceramic layer 31 of the present example embodiment are fewer than the strain portions 52 existing in the conventional inner ceramic layer 31.

In the multilayer ceramic capacitor 1 of the present example embodiment, in a cross section parallel to the height direction T and the length direction L, an area of the strain portion 52 is 5% or less of an area of the ceramic layer 28.

In the cross section of the inner ceramic layer 31 shown in FIG. 9, the area of the strain portion 52 is about 5% or less of the total area of the inner ceramic layer 31, for example.

The ceramic layer 28 includes ceramic grains. The ceramic grains are not illustrated. The ceramic grains are, for example, particles of barium titanate.

In the multilayer ceramic capacitor 1 of the present example embodiment, in a cross section parallel to the height direction T and the length direction L, the longest diameter of the strain portion 52 is about 0.5 μm or less with respect to one ceramic grain, for example. The description “the longest diameter of the strain portion is about 0.5 μm or less with respect to the one ceramic grain” indicates that “the longest diameter of the strain portion included inside one ceramic grain is about 0.5 μm or less”, for example.

In the multilayer ceramic capacitor 1 of the present example embodiment, the degree of dispersion of the distribution of the strain portions 52 is about 1.00 or less in a cross section parallel to the height direction T and the length direction L, for example.

A method for observing grain boundaries and the like will be described. A sample used for observation is prepared as follows. The multilayer ceramic capacitor 1 is embedded in resin and polished. The polishing exposes an LT cross section at a position ½ of the length in the width direction W of the multilayer ceramic capacitor 1. The LT cross section is observed in a field of view that includes 10 or more internal electrodes 27.

This will be described with reference to FIG. 4. The ranges of the frame 92, the frame 93, and the frame 94 in FIG. 4 correspond to the field of view. The length in the height direction T of the frame 93 is indicated by arrow 60. The length 60 is, for example, about 20 μm or more and about 200 μm or less.

The number of frames to be observed is three. The three frames are located at the middle portion in the height direction T and at both end portions in the height direction T. The middle position in the height direction T in the frame 92 is defined as a position 96. The middle position in the height direction T in the frame 93 is defined as a position 97. The middle position in the height direction T in the frame 94 is defined as a position 98.

The distance in the height direction T between the first main surface 3 and the position 96 is defined as a length 62. The distance in the height direction T between the position 96 and the position 97 is defined as a length 63. The distance in the height direction T between the position 97 and the position 98 is defined as a length 64. The distance in the height direction T between the position 98 and the second main surface 4 is defined as a length 65. The length 62, length 63, length 64, and length 65 are equal or substantially equal.

By observing the ranges of the frame 92, the frame 93, and the frame 94 as the field of view, it is possible to observe three locations, which are the middle portion in the height direction T and both end portions in the height direction T.

The three locations of the frame 92, the frame 93, and the frame 94 are photographed by EBSD (Electron Backscattered Diffraction) technique. The size of the first metal grains 40 included in the external electrode 22 is calculated. The calculation of the size is performed by software processing in the EBSD technique. By using EDX (Energy Dispersive X-ray Spectroscopy) in combination with the EBSD technique, the difference in composition between the external electrode 22 and the internal electrode 27 can be grasped. Due to the difference in composition, the external electrode 22 can be regionally separated from the internal electrode 27. After the regional separation, the grain size of the first metal grains 40 is calculated.

The thickness 67 of the internal electrode 27 in the height direction T can be measured by grasping the scale from an SEM (Scanning Electron Microscope) image of the LT cross section.

The method for measuring the thickness 67 is as follows. In the aforementioned LT cross section, the internal electrode 27 is divided into five sections of equal or substantially equal length in the length direction L. The thickness of the internal electrode 27 in the height direction T is measured at the center position in the length direction L in each section. The average value of the five measured values is taken as the thickness 67 of the internal electrode 27 in the height direction T.

For quantification of the size of the first metal grains 40 of the external electrode 22, it is desirable to photograph the vicinity of the bonding portion 50 with the internal electrode 27. However, similar structural analysis results can be obtained within a range of one-third or less of the thickness direction, that is, the length in the length direction L, of the external electrode 22 from the interface between the ceramic layer 28 and the external electrode 22.

The stress evaluation will be described. Confirmation of whether the ceramic layer 28 has a configuration with little strain is performed as follows. As described above, the multilayer ceramic capacitor 1 is embedded in resin, and polished. The frame 92, the frame 93, and the frame 94 are photographed by the EBSD technique. By performing image analysis on the images corresponding to each frame, the strain portion 52 is identified and its area is determined. The criterion for determining the strain portion 52 is a portion pseudo-color displayed in an orientation difference map (Kernel Average Misorientation Map), where the average orientation (°) difference between adjacent measurement points within the same crystal particle (orientation angle difference is within 5°) is shown.

The degree of dispersion regarding the distribution of the strain portions 52 is calculated as follows. The strain portions 52 are binarized by image analysis software. The variation (σ) of the center-to-center distances of the strain portions 52 divided by the average value of the center-to-center distances of the strain portions 52 is calculated and defined as the degree of dispersion.

The judgment criteria will be explained. For example, the phrase “two or more grain boundaries 46 of the first metal grains 40 are present at the bonding portion 50 between the internal electrode 27 and the external electrode 22” indicates that, as a result of observing three locations including the middle portion and both end portions in the height direction T, at least one location includes at least one internal electrode 27 in which “two or more grain boundaries 46 of the first metal grains 40 are present at the bonding portion 50 between the internal electrode 27 and the external electrode 22”.

The same applies to other evaluation criteria. For example, if at least one internal electrode 27 among the internal electrodes 27 included in at least one of the frames 92, 93, or 94 satisfies a desired condition, the multilayer ceramic capacitor 1 satisfies that condition. Further, the grain diameter is an average particle size based on D50.

The bonding between the internal electrode 27 and the external electrode 22 has been described above using the second internal electrode 33 and the second end surface 8 as examples. The content described above similarly applies to the bonding between the first internal electrode 32 and the external electrode 22 at the first end surface 7.

A non-limiting example of a method for measuring the length and thickness of each portion will be described. The multilayer ceramic capacitor 1 is polished to the middle position in the width direction W. The LT cross section exposed by polishing is observed with an optical microscope or the like, and the length and thickness are measured.

An example manufacturing method for obtaining the multilayer ceramic capacitor 1 of the present example embodiment will be described. The entire manufacturing method of the multilayer ceramic capacitor 1 will be described later. Here, characteristic matters for obtaining the multilayer ceramic capacitor 1 of the present example embodiment will be described.

In order to improve the bonding property between the internal electrode 27 and the external electrode 22, it is desirable that the contact area between the internal electrode 27 and the external electrode 22 is large at a stage before the metal included in the internal electrode 27 and the metal included in the external electrode 22 mutually diffuse in the surface. The second internal electrode 33 will be described as an example. The following description also applies to the first internal electrode 32.

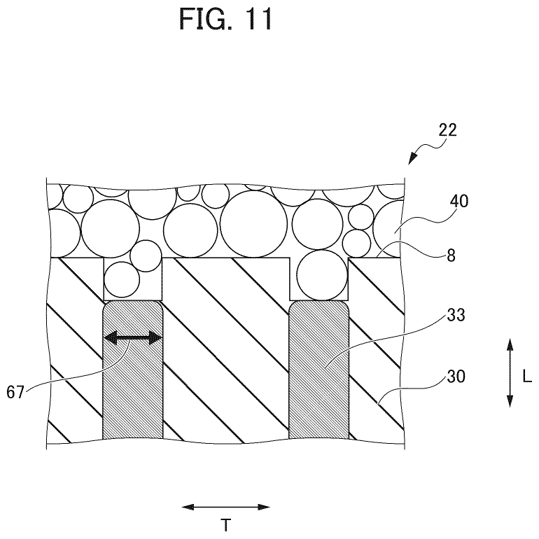

FIG. 11 is an LT cross-sectional view showing an interface between the second internal electrode 33 and the external electrode 22 before surface diffusion. As shown in FIG. 11, even when the second internal electrode 33 before firing is not exposed on the surface layer of the inner ceramic layer 31, the bonding between the second internal electrode 33 and the external electrode 22 can be stabilized by the following manner, such that it is possible to provide a configuration with less strain in the ceramic layer 28.

When the thickness 67 of the second internal electrode 33 in the height direction T is about 0.3 μm or more and about 2.0 μm or less, the particle size of the metal powder used for the external electrode 22 is set to about 0.2 μm or more and about 1.0 μm or less, for example. This makes it possible to stabilize the bonding between the second internal electrode 33 and the external electrode 22.

As the ratio of coarse particles in the metal powder used for the external electrode 22 increases, the probability of contact between the metal powder and the second internal electrode 33 decreases. Therefore, it is preferable to remove coarse particles from the metal powder used for the external electrode 22. An example of a method for removing coarse particles is wet classification treatment.

The crystallite diameter per particle of the metal powder used for the external electrode 22 is preferably about 0.01 μm or more and about 0.30 μm or less, for example. The shape of the metal powder preferably has a circularity of about 0.6 or more, for example.

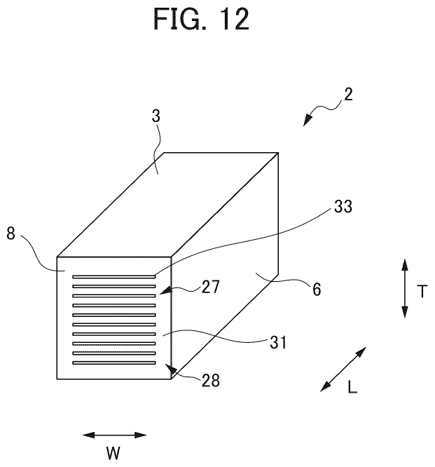

Another method and structure for improving the bonding property between the internal electrodes 27 and the external electrodes 22 will be described. FIG. 12 is a perspective view showing an outline of the ceramic base body 2. As shown in FIG. 12, before forming the external electrodes 22, the ceramic layer 28 on the WT surface where the internal electrodes 27 are exposed is removed in the ceramic base body 2. This exposes the recessed internal electrodes 27. By removing the ceramic layer 28, the second internal electrodes 33 that are not exposed on the surface layer of the inner ceramic layer 31 are exposed. Examples of a method for removing the ceramic layer 28 include sandblasting.

The exposure amount of the internal electrodes 27 can be determined by measuring the area ratio of nickel with a fluorescent X-ray apparatus. The preferred area ratio of nickel is about 30% or more and about 60% or less, for example.

In order to form the external electrode 22, application, drying, and firing of an electrically conductive paste for the external electrode 22 are necessary. The electrically conductive paste includes metal powder, glass, and a binder. Portions other than the metal powder, that is, the glass and the binder, are considered to inhibit bonding between the internal electrode 27 and the external electrode 22.

It is preferred that the binder does not remain at the timing of bonding between the internal electrode 27 and the external electrode 22. Therefore, it is preferable to use a binder material with good thermal decomposition properties and to fire the electrically conductive paste under firing conditions with good degreasing properties.

Preferable firing conditions are a temperature range in which the binder thermally decomposes, a reducing atmosphere for copper and nickel, and an oxidizing atmosphere for carbon. A preferred example of firing conditions is maintaining an oxygen partial pressure of about 1.0E-10 P/atm or more and about 1.0E-18 P/atm or less at a temperature of about 600° C. or more and about 850° C. or less for about 5 minutes or more, for example.

In order to promote degreasing, it is preferable that firing is performed at a temperature equal to or lower than a temperature at which the internal electrode 27 and the external electrode 22 undergo surface diffusion. In addition, the timing of bonding between the internal electrode 27 and the external electrode 22 may be delayed. As a way to delay the bonding timing, there is method to attach one or more elements selected from the group consisting of silicon, titanium, aluminum, zirconium, tin, and the like to the surface of metal powder such as copper powder. By using an electrically conductive paste including these elements, it is possible to delay sintering.

In order not to inhibit bonding between the internal electrode 27 and the external electrode 22, it is preferable that glass is made into fine particles and that the addition amount thereof is small. It is preferable that the particle size of glass particles is about 80% or less with respect to the thickness 67 of the internal electrode 27, for example. It is preferable that the addition amount of glass particles is about 5 vol % or more and about 40 vol % or less with respect to the content of copper powder, for example.

A non-limiting example of a manufacturing method of the multilayer ceramic capacitor 1 will be described. A dielectric sheet and an electrically conductive paste for manufacturing internal electrodes are prepared. The dielectric sheet and the electrically conductive paste for manufacturing internal electrodes include a binder and a solvent. The binder and the solvent may be a known organic binder and organic solvent.

The electrically conductive paste for manufacturing internal electrodes is printed on the dielectric sheet in a predetermined pattern. An internal electrode pattern is formed by this printing. Examples of the printing method include screen printing and gravure printing.

A predetermined number of dielectric sheets for manufacturing the outer layer portion are laminated. No internal electrode pattern is printed on the dielectric sheets for manufacturing the outer layer portion. Dielectric sheets with printed internal electrode patterns are sequentially laminated on the laminated dielectric sheets. A predetermined number of dielectric sheets for manufacturing the outer layer portion are laminated thereon. A multilayer sheet is produced by these lamination processes.

The multilayer sheet is pressed in the height direction to produce a multilayer block. Examples of the pressing method include hydrostatic pressing.

The multilayer block is cut to a predetermined size. Multilayer chips are cut out by this cutting. The corner portions and ridge portions of the multilayer chips may be rounded during cutting. Examples of the method for rounding include barrel polishing.

The multilayer chips are fired. Ceramic base bodies are produced by this firing. The preferred firing temperature is about 900° C. or more and about 1110° C. or less, for example. The firing temperature changes according to the materials of the dielectric and the internal electrode.

Terminal electrodes are formed. An electrically conductive paste that functions as the external electrode 22 is applied to the two end surfaces of the ceramic base body 2. The electrically conductive paste includes metal and glass. Examples of a method for applying the electrically conductive paste include dipping. After application, firing is performed to form the external electrode 22. The preferred firing temperature is about 500° C. or more and about 900° C. or less, for example. The preferred firing time is about 30 minutes or more and about 2 hours or less, for example.

A nickel plating film 24 is formed on the surface of the external electrode 22. A tin plating film 25 is formed on the surface of the nickel plating film 24. The nickel plating film 24 and the tin plating film 25 are formed by a barrel plating method or the like. In this way, the multilayer ceramic capacitor 1 is manufactured.

It is possible for the multilayer ceramic capacitor 1 of the present example embodiment to realize a configuration with less strain in the ceramic layer 28 at the interface with the terminal electrode 19. This makes it possible to reduce or prevent a decrease in reliability due to excessive strain in the ceramic layer 28 at the interface with the terminal electrode 19.

Although example embodiments of the present invention have been described above, the present invention is not limited to the example embodiments described above, and various changes and modifications are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic base body including a plurality of ceramic layers and a plurality of internal electrodes that are laminated, and six surfaces including a first main surface and a second main surface opposed to each other in a height direction, a first lateral surface and a second lateral surface opposed to each other in a width direction orthogonal to the height direction, and a first end surface and a second end surface opposed to each other in a length direction orthogonal to the height direction and the width direction; and
external electrodes each provided on the ceramic base body and each connected to a portion of the plurality of internal electrodes; wherein
each of the external electrodes includes first metal grains; wherein
in a cross section parallel to the height direction and the length direction, two or more grain boundaries of the first metal grains are present at a bonding portion between the plurality of internal electrodes and a corresponding one of the external electrodes; and
a grain diameter of the first metal grains each having a grain boundary present at the bonding portion is about 1.2 times or less a thickness of one of the plurality of internal electrodes in the height direction.

2. The multilayer ceramic capacitor according to claim 1, wherein
the thickness of the one of the plurality of internal electrodes in the height direction is about 0.3 μm or more and about 2.0 μm or less; and
the grain diameter of the first metal grains each having a grain boundary present at the bonding portion is about 0.1 μm or more and about 0.8 μm or less.

3. The multilayer ceramic capacitor according to claim 1, wherein a coefficient of variation of the grain diameter of the first metal grains each including a grain boundary present at the bonding portion is about 20% or less.

4. The multilayer ceramic capacitor according to claim 1, wherein
the external electrodes each include a glass portion; and
the glass portion is in contact with at least one of the plurality of internal electrodes or the plurality of ceramic layers.

5. The multilayer ceramic capacitor according to claim 1, wherein
a strain portion is present in the plurality of ceramic layers; and
in a cross section parallel to the height direction and the length direction, an area of the strain portion is about 5% or less of an area of the plurality of ceramic layers.

6. The multilayer ceramic capacitor according to claim 1, wherein
a strain portion is present in the plurality of ceramic layers;
the plurality of ceramic layers includes ceramic grains; and
in a cross section parallel to the height direction and the length direction, a maximum diameter of the strain portion is about 0.5 μm or less with respect to one of the ceramic grains.

7. The multilayer ceramic capacitor according to claim 1, wherein
a strain portion is present in the plurality of ceramic layers; and
in a cross section parallel to the height direction and the length direction, a degree of dispersion of a distribution of the strain portion is about 1.00 or less.

8. The multilayer ceramic capacitor according to claim 1, wherein the multilayer ceramic capacitor includes two terminals, three terminals, or more than three terminals.

9. The multilayer ceramic capacitor according to claim 1, wherein the plurality of internal electrodes includes a second internal electrode that includes second metal grains.

10. The multilayer ceramic capacitor according to claim 9, wherein the second metal grains are located at a tip of the second internal electrode.

11. The multilayer ceramic capacitor according to claim 10, wherein the tip of the second electrode is in contact with the corresponding one of the external electrodes at the bonding portion.

12. The multilayer ceramic capacitor according to claim 9, wherein the second metal grains include nickel.

13. The multilayer ceramic capacitor according to claim 1, wherein the first metal grains include copper.

14. The multilayer ceramic capacitor according to claim 1, wherein the first metal grains include metal grains having grain boundaries in contact with the bonding portion and metal grains having grain boundaries not in contact with the bonding portion.

15. The multilayer ceramic capacitor according to claim 11, wherein the tip of the second electrode protrudes from an end surface toward the corresponding one of the external electrodes.

16. The multilayer ceramic capacitor according to claim 1, wherein the first metal grains have particles with a particle size of about 1.0 μm or less.

17. The multilayer ceramic capacitor according to claim 9, wherein two bonding metal grains are in contact with the second internal electrode.

18. The multilayer ceramic capacitor according to claim 17, wherein a grain diameter of each of the two bonding metal grains is about 1.2 times or less of the thickness of the second internal electrode.

19. The multilayer ceramic capacitor according to claim 18, wherein the thickness of the second internal electrode in the height direction is about 0.3 μm or more and about 2.0 μm or less.

20. The multilayer ceramic capacitor according to claim 18, wherein the grain diameter of each of the two bonding metal grains is about 0.1 μm or more and about 0.8 μm or less.
